(19) United States
(12) Patent Application Publication
(10) Pub. No.: US 2022/0197335 A1
(43) Pub. Date: Jun. 23, 2022

(54) Retractable Attachments For Stylus Pens

(71) Applicant: Hewlett-Packard Development Company, L.P., Spring, TX (US)

(72) Inventors: Derek Kanas, Spring, TX (US); Chan-Woo Park, Spring, TX (US)

(73) Assignee: Hewlett-Packard Development Company, L.P., Spring, TX (US)

(21) Appl. No.: 17/606,536

(22) PCT Filed: Jul. 26, 2019
(86) PCT No.: PCT/US2019/043660

§ 371 Date: Oct. 26, 2021

(51) Int. Cl. G06F 1/16; G06F 3/0354

(52) U.S. Cl. CPC G06F 1/1607; G06F 2200/1632; G06F 3/03545

(57) ABSTRACT

Examples disclosed herein relate to a computing device with an attachment mechanism to secure a stylus pen. An example device includes a slot disposed in an outer surface of the enclosure of the computing device and a spool disposed inside the enclosure adjacent to the slot. The device also includes a band disposed adjacent to the slot and attached, at a first end, to the spool. The band is configured to be extracted through the slot and wrapped around a stylus pen operable with the computing device. The band is further configured to retract within the slot and wrap around the spool when not in use.

### BACKGROUND

The stylus pen is becoming a more common accessory for computing devices such as convertible notebooks, tablets, and even smart phones. Stylus pens can be used to input commands to a computer screen, taking the place of a user's finger. For example, stylus pens can be used as a pointing device, selection device, or writing tool. Some stylus pens have built-in memory and other electronics that can be used to provide additional inputs to the computing device. For example, buttons may be provided on the barrel of the pen to enable the user to transmit certain user actions to the computing device. Such a stylus pen may be referred to as an active pen or digital pen.

### DESCRIPTION OF THE DRAWINGS

Certain examples are described in the following detailed description and in reference to the drawings, in which:

FIG. 1 is a perspective view of an computing device with an attachment mechanism to secure a stylus pen;

FIG. 2 is a perspective view of another computing device with an attachment mechanism to secure a stylus pen;

FIG. 3A is a perspective view of an example attachment mechanism in accordance with examples;

FIG. 3B shows the attachment mechanism of FIG. 3A in an extracted position and holding the pen;

FIG. 4 is a close-up perspective view of an example attachment mechanism in accordance with examples;

FIG. 5A is a perspective view of another example attachment mechanism in accordance with examples;

FIG. 5B shows the attachment mechanism of the FIG. 5A in an extracted position and holding the pen; and

FIG. 6 is a process flow diagram of a method of manufacturing a computing device with an attachment mechanism for attaching a stylus pen.

### DETAILED DESCRIPTION

As stylus pens becoming more expensive, it is useful to have a reliable method to attach the pen to the computing device so that it will not be lost. Traditional attachment methods, such as slots or recesses, often have an undesirable effect on the industrial design of the computing device. Magnets have minimal effect on industrial design, but may not be secure enough to ensure that the pen will not be accidentally dislodged. The present disclosure describes techniques for securely attaching a stylus pen to a computing device without significantly affecting the industrial design of the computing device.

The attachment device described herein includes a retractable band that is housed within the computing device and accessible through a thin slot. The band can be pulled outward by the user and wrapped around the stylus pen to secure the pen to the computing device. When the pen is removed, the band can be retracted back into the computing device and hidden from view.

In one example, the band is a thin metal spring coil that wraps around the pen. To attach the pen to the computing device, the pen can be placed against the side of the computing device in the vicinity of the slot and rotated to extract the spring coil. The energy stored in the spring causes it to naturally wrap around the pen and hold it securely against the side of the computing device. When not being used, the spring coil will automatically retract and coil back up inside the unit.

In another example, the band is a ribbon of cloth or other flexible material. To attach the pen to the computing device, the ribbon can be extracted by the user and wrapped around the pen. An attachment mechanism at the end of the ribbon can be secured against a complimentary attachment mechanism in or on the computing device. When not being used, the ribbon will automatically retract and coil back up inside the enclosure of the computing device.

The examples described herein provide a reliable pen attachment method that does not significantly affect the industrial design of the computing device. When not in use, the band retracts into the unit, leaving a small inconspicuous slot on the outer surface. Having a reliable pen attachment mechanism that does not significantly affect the aesthetics of the computing device may make the purchasing of such computing devices more attractive to consumers.

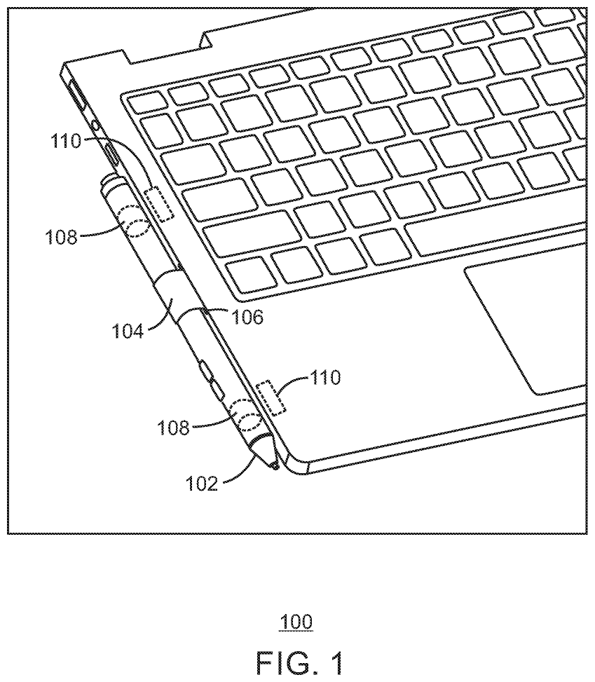

FIG. 1 is a perspective view of a computing device with an attachment mechanism to secure a stylus pen. The computing device 100 may be any type of mobile electronic device configured to receive input through a stylus pen 102, such as a laptop computer, tablet computer, smart phone, digital assistant, and others. The stylus pen 102 is configured as an input device that allows a user to input user instructions to the computing device 100 through interactions between the stylus pen 102 and the computing device's display screen. The stylus pen 102 may be any suitable type of stylus pen, including a digital pen, an active pen, and others. The stylus pen 102 may include circuitry such as memory, processing resources, buttons, an energy source such as a battery, and others.

The attachment mechanism enables a user to securely attach the stylus pen 102 to the side of the computing device 100. The attachment mechanism includes a band 104 that can be extracted from a slot 106 disposed in the side of the enclosure of the computing device. When not in use, the band 104 is retracted within the slot 106 and hidden from view. To attach the pen 102 to the computing device 100, the user can extract the band 104 and wrap the band 104 around the pen 102 to secure it to the computing device 100. When the user detaches the pen 102 from the computing device 100, the band 104 retracts back into the enclosure. In the example shown in FIG. 1, the band 104 is positioned to couple to the pen 102 at or near the center of the pen 102.

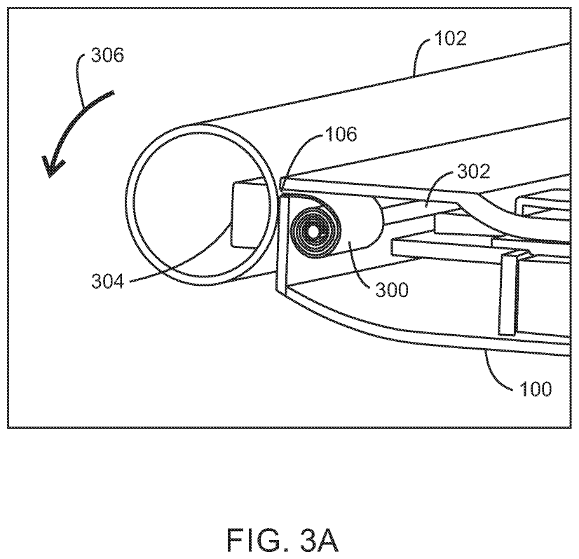

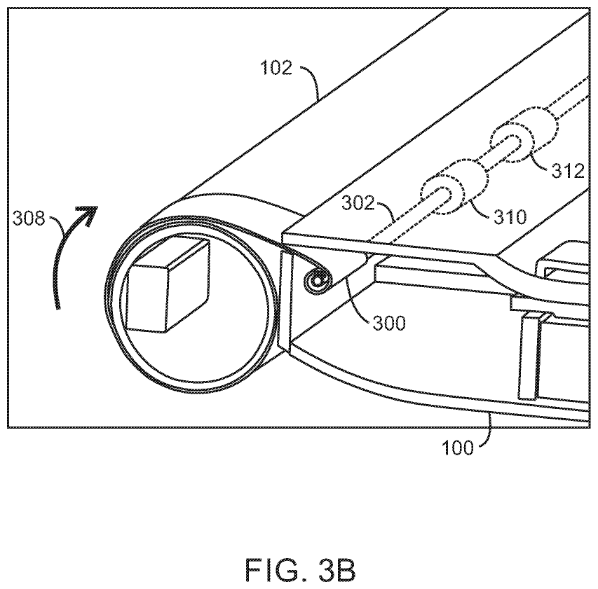

The band 104 may be any suitable material including metal, plastic, cloth, and others. In some examples, the band 104 is a metal spring coil that wraps around the pen such that the pen is held in place by the inherent tendency of the spring coil to curl around the pen 102. In some examples, the band 104 is a ribbon of material such as cloth or plastic. The ribbon can be extracted by the user, wrapped around the pen 102 and coupled to an external surface of the enclosure such that the pen 102 is held against the side of the enclosure by the pressure applied by the ribbon. Examples of these techniques are described further in relation to FIGS. 3-7.

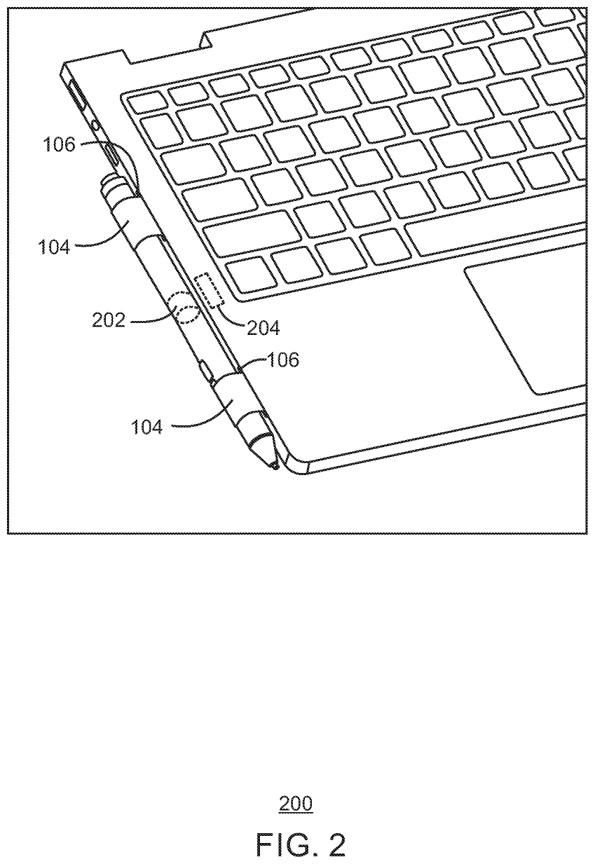

The width of the band 104 may be any suitable dimension. In some examples, the width of the band 104 is small compared to the length of the pen 102. For example, the width of the band 104 may be approximately 0.25 inch, 0.5 inch, 1.0 inch, or any value in between. In some examples, the width of the band 104 is comparable to the length of the pen 102. For example, the width of the band 104 may be equal to half the length of the pen 102, three quarters of the length the pen 102, the full length of the pen 102, or any value in between. Additionally, although one band 104 is shown, the attachment mechanism may include two or more bands as shown in FIG. 2, for example.

In addition to the band 104, the attachment of the pen 102 to the computing device 100 may also be aided by magnets. For example, as shown in FIG. 1, the pen 102 may include a pair of magnets 108 disposed inside the pen 102 near the ends of the pen 102. The magnets 108 in the pen 102 may be configured to couple with corresponding magnets 110 disposed inside the enclosure of the computing device 100. The magnetic coupling between the pen 102 and the computing device 100 provides additional strength to the connection. The magnetic coupling also serves to keep the pen 102 aligned with the side of the computing device 100 and prevents the pen from sliding out of the band 104.

FIG. 2 is a perspective view of another computing device with an attachment mechanism to secure a stylus pen. As shown in FIG. 2, the attachment mechanism can include two bands 104. As described above in relation to FIG. 1, each band 104 is configured to be extracted from corresponding slots 106 disposed in the side of the enclosure and retract back into the enclosure through the slots 106 when not in use. Each of the bands 104 may have the same properties described above in relation to FIG. 1 and further described below in relation to FIGS. 3-7. In the example shown in FIG. 2, one band 104 is positioned to couple to the pen 102 near one end of the pen 102, and the other band 104 is positioned to couple to the pen 102 at the opposite end of the pen 102. In some examples, the pen 102 may also include an internal magnet 202 disposed near the center of the pen 102 and configured to couple with a corresponding magnet 204 inside the enclosure of the computing device 200.

FIG. 3A is a perspective view of an example attachment mechanism in accordance with examples. In this example, the band (shown in FIGS. 1 and 2 as item 104) is a metal spring coil 300 and the attachment mechanism includes a spool 302 disposed inside the enclosure adjacent to the slot 106. A first end of the spring coil 300 is attached to the spool 302 and a second end of the spring coil 300 is disposed within the slot 106. In some examples, the end of the spring coil 300 disposed in the slot 106 may be enlarged or tabbed to prevent the end of the spring coil 300 from slipping inside the enclosure of the computing device 100.

In FIG. 3A, the spring coil 300 is shown in the retracted position and is wound around the spool 302. To attach the pen 102 to the computing device 100, the user can manually extract the spring coil 300 from the slot 106 and allow the spring coil 300 to wrap around the pen 102. The spring coil 300 may be extracted by the user manually pulling on the exposed second end of the spring coil 300. Additionally, in some examples, the second end of the spring coil 300 may be extracted magnetically. In such examples, the pen 102 can include an internal magnet 304 configured to attract the second end of the metal spring coil 300 and pull the spring coil 300 out of the enclosure through the slot 106. Once extracted, the user can then rotate the pen 102 against the side of the enclosure in the direction indicated by the arrow 306 to cause the spring coil 300 to coil itself around the pen 102.

The spring coil 300 may be a band of metal that is rolled into the shape of a spiral coil, sometimes referred to as a negator spring or laminar spring. The spring coil 300 can include any type of metal suitable for forming a spring coil, including stainless steel, aluminum, copper, bronze, and others. In examples wherein the spring coil spring coil 300 is magnetically extracted, the spring coil 300 may be formed of any suitable magnetic metal, including ferritic stainless steel, and others.

FIG. 3B shows the attachment mechanism of FIG. 3A in an extracted position and holding the pen 102. The radius of the pen 102 will be larger than the resting radius of the spring coil 300 when wound around the spool 302. Therefore, the energy stored in the spring coil 300 will cause it to coil tightly around the pen 102 without the need for any additional coupling mechanism between pen 102 and the spring coil 300.

To release the pen 102, the user can rotate the pen in the direction indicated by the arrow 308. As the pen 102 rotates, the spring coil 300 retracts back into the enclosure through the slot 106 and wraps around the spool 302. In some examples, the rotation of the spool 302 is caused in part by the force applied by the user and in part by the energy released by the spring coil 300 as it wraps around the smaller radius spool 302. In some examples, the spool 302 may also be coupled to a torsion spring 310 that applies a rotational force to the spool 302 to retract the spring coil 300 when not in use. The torsion spring 310 can bias the spring coil 300 in the retracted position, thereby pulling the spring coil 300 back into the enclosure when not it use or when released by the user.

In some examples, the attachment mechanism also includes a latch 312 coupled to the spool 302 and configured to lock the spool 302 in place in an extracted position. The latch 312 can be locked when the spring coil 300 is fully extracted to counteract the torque applied by the torsion spring 310 and stop the spool 302 from rotating when the spring coil 300 is holding the pen 102. When the latch 312 is locked and the user wants to detach the pen 102, the user can pull on the spring coil 300 to unlock the latch 312 and allow the spool 302 to rotate.

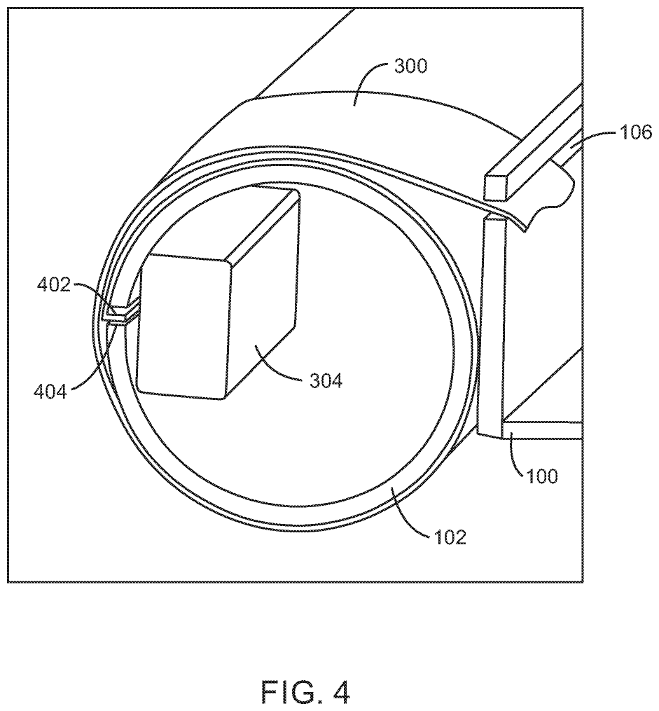

FIG. 4 is a close-up perspective view of an example attachment mechanism in accordance with examples. The attachment mechanism shown in FIG. 4 includes a spring coil 300 as described in relation to FIGS. 3A and 3B. Additionally, although the spool 300, torsion spring 310, and latch 312 are not shown, it will be appreciated that the attachment mechanism may include some or all of these additional features.

In the example shown in FIG. 4, the attachment mechanism also includes a small tab 402 at the second end of the spring coil 300. The tab 402 is configured to engage with a corresponding slot 404 included in the pen 102. The tab 402 may also be sized to prevent the tab 402 from passing through the slot 106. When the user attaches the pen 102 to the computing device 100, the user can cause the slot 404 to engage the tab 402 to facilitate the extraction of the spring coil 300 from the slot 106. The tab 402 and slot 404 may be used in addition to the magnet 304, which exerts an additional force to extract the spring coil 300. However, in some examples, the magnet 304 is not included and the tab 402 and slot 404 are sufficient to extract the spring coil 300.

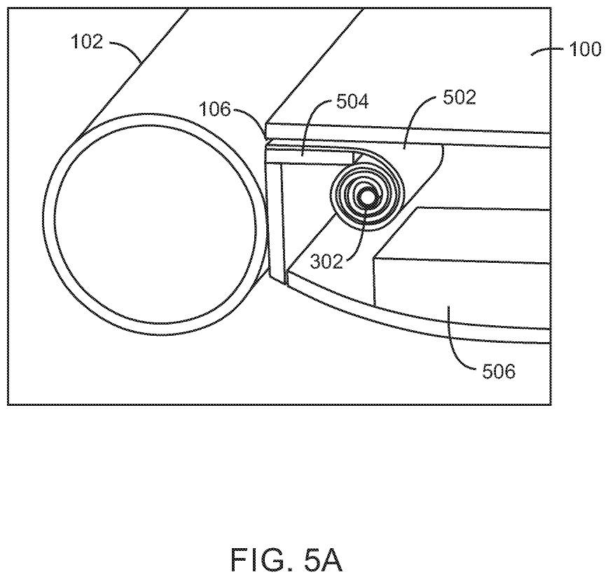

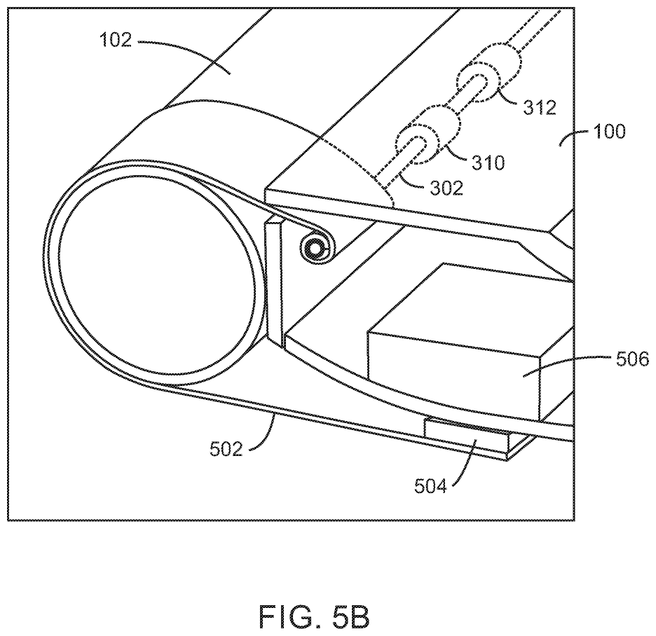

FIG. 5A is a perspective view of another example attachment mechanism in accordance with examples. In this example, the band (shown in FIGS. 1 and 2 as item 104) is a ribbon 502 of flexible material with a coupling mechanism 504. A first end of the ribbon 502 is coupled to the spool 302 and the second end of the ribbon 502 is fixed to the coupling mechanism 504, which is disposed in the slot 106.

In FIG. 5A, the ribbon 502 is shown in the retracted position and is wound around the spool 302. To attach the pen 102 to the computing device 100, the user can manually extract the ribbon 502 from the slot 106, wrap the ribbon 502 around the pen 102, and attach the coupling mechanism 504 to an external surface of the computing device 100 as shown in FIG. 5B. The ribbon 502 may be extracted by the user manually pulling on an exposed end of the coupling mechanism 504. Additionally, in some examples, the coupling mechanism 504 may be drawn out of the slot 106 by a magnet (not shown) disposed in the pen 102. When fully retracted, the coupling mechanism 504 may be flush with the external surface of the enclosure of the computing device 100.

The ribbon 502 may be made of any suitable material, including a natural cloth, a synthetic cloth, or a combination thereof. The ribbon 502 may also be made of flexible polymers such as biaxially-oriented polyethylene terephthalate (BoPET) and others.

FIG. 5B shows the attachment mechanism of FIG. 5A in an extracted position and holding the pen 102. As shown in FIGS. 5A and 5B, the coupling mechanism 504 may be a magnet configured to couple to a complimentary magnet 506 disposed within the enclosure of the computing device 100. However, in some examples, the coupling mechanism 504 can also be a non-magnetic fastener such as a snap fastener configured to be coupled to a complimentary fastener disposed on an external surface of the enclosure. In some examples, the ribbon 502 may be elastic so that when the coupling mechanism 504 is coupled to the enclosure, the elasticity of the ribbon 502 applies added pressure to hold the pen 102 more securely against the side of the computing device 100.

The spool 302 may also be coupled to the torsion spring 310 that applies a rotational force to the spool 302 to retract the ribbon 502 when not in use. The torsion spring 310 can bias the ribbon 502 toward the retracted position, thereby pulling the ribbon 502 back into the enclosure when not it use or when released by the user. The attachment mechanism can also include the latch 312, which is coupled to the spool 302 and configured to lock the spool 302 in place in an extracted position. The latch 312 can be locked when the ribbon 502 is fully extracted to counteract the torque applied by the torsion spring 310 and stop the spool 302 from rotating when the ribbon 502 is holding the pen 102. When the latch 312 is locked and the user wants to detach the pen 102, the user can pull on the ribbon 502 to unlock the latch 312 and allow the spool 302 to rotate.

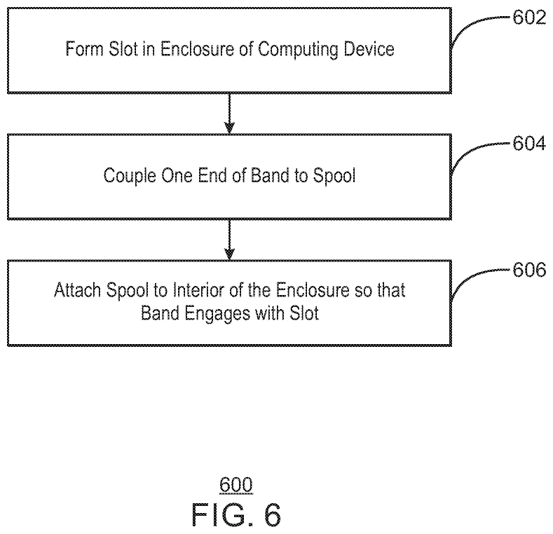

FIG. 6 is a process flow diagram of a method of manufacturing a computing device with an attachment mechanism for attaching a stylus pen. The method may be performed to manufacture a computing device with any of the example attachment mechanisms described above. The method may begin a block 602.

At block 602, a slot is formed in an enclosure of the computing device. The slot provides a small opening that allows a band to be drawn from the interior of the computing device's enclosure. Additional slots may be formed along the length of the enclosure depending on the number of bands.

At block 604, one end of a band is coupled to a spool. The band may be a spring coil or a ribbon of flexible material. As an example, a torsion spring and latch can also be coupled to the spool. In some examples, two or more bands may be coupled to the spool at different locations along the length of the spool. The end of the band not coupled to the spool (the free end) may have a tab or a coupling mechanism such as a magnet.

At block 606, the spool is attached to the interior of the enclosure of the computing device. The spool is attached to the enclosure in a way that allows the spool to rotate about its axis. The spool is also fixed to the enclosure at a position that allows the free end of the band to engage with the slot. In examples wherein the band is to include a tab or coupling mechanism at its free end, the band may be pulled through the slot to form the tab or attach the coupling mechanism.

It is to be understood that the block diagram of FIG. 6 is not intended to indicate that the method 600 is to include all of the actions shown in FIG. 6. Rather, the method 600 can include fewer or additional components not illustrated in FIG. 6. Additionally, the order in which the actions are performed may differ from what is shown in FIG. 6.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A computing device with an attachment mechanism to secure a stylus pen, comprising:
a slot disposed in an outer surface of an enclosure of the computing device;
a spool disposed inside the enclosure adjacent to the slot;
a band disposed adjacent to the slot and attached, at a first end, to the spool, wherein the band is configured to be extracted through the slot and wrapped around a stylus pen operable with the computing device, and wherein the band is further configured to retract within the slot and wrap around the spool when not in use.

2. The computing device of claim 1, wherein the band is a metal spring coil configured to couple to the pen at a second end of the band and wrap around the stylus pen to secure the pen to the computing device.

3. The computing device of claim 2, wherein the metal spring coil is configured to couple to the pen by being magnetically attracted to a magnet disposed inside the stylus pen.

4. The computing device of claim 2, wherein the second end of the band comprises a tab, and wherein the metal spring coil is configured to couple to the pen by insertion of the tab into a slot disposed on the stylus pen.

5. The computing device of claim 1, wherein the band is a ribbon of material with a coupling mechanism disposed at a second end of the band, the coupling mechanism to couple the second end of the band to the outer surface of the enclosure.

6. The computing device of claim 5, wherein the coupling mechanism is a magnet configured to couple to a complimentary magnet disposed within the enclosure.

7. An attachment mechanism for attaching a stylus pen to a computing device, comprising:
a slot disposed in an outer surface of an enclosure of a computing device;
a spool disposed inside the enclosure adjacent to the slot;
a metal spring coil disposed adjacent to the slot and attached, at a first end, to the spool, wherein the metal spring coil is configured to be extracted through the slot and wrapped around a stylus pen operable with the computing device, and wherein the metal spring coil is further configured to retract within the slot and wrap around the spool when not in use.

8. The attachment mechanism of claim 7, wherein the metal spring coil is configured to couple to the pen at a second end of the metal spring coil and wherein rotation of the pen causes the metal spring coil to wrap around the stylus pen.

9. The attachment mechanism of claim 8, wherein the metal spring coil is configured to couple to the pen by being magnetically attracted to a magnet disposed inside the stylus pen.

10. The attachment mechanism of claim 8, wherein the second end of the band comprises a tab, and wherein the metal spring coil is configured to couple to the pen by insertion of the tab into a slot disposed on the stylus pen.

11. The attachment mechanism of claim 7, comprising a torsion spring coupled to the spool and configured to apply a rotational force to the spool to retract the metal spring coil when not in use.

12. The attachment mechanism of claim 7, comprising a latch coupled to the spool and configured to lock the spool in place in an extracted position.

13. An attachment mechanism for attaching a stylus pen to a computing device, comprising:
a slot disposed in an outer surface of an enclosure of the computing device;
a spool disposed inside the enclosure adjacent to the slot;
a ribbon of material disposed adjacent to the slot and attached, at a first end, to the spool, wherein the ribbon of material is configured to be extracted through the slot and wrapped around a stylus pen operable with the computing device, and wherein the ribbon of material is further configured to retract within the slot and wrap around the spool when not in use.

14. The attachment mechanism of claim 13, comprising a coupling mechanism disposed at a second end of the ribbon of material, the coupling mechanism to couple the second end of the ribbon of material to the outer surface of the enclosure.

15. The attachment mechanism of claim 14, wherein the coupling mechanism is a magnet configured to couple to a complimentary magnet disposed within the enclosure.
